(19) United States
(12) Patent Application Publication
(10) Pub. No.: US 2006/0158317 A1
(43) Pub. Date: Jul. 20, 2006

(54) Reader/writer device

(76) Inventors: Shoji Kuriki, Kanagawa (JP); Yoshinori Mori, Kanagawa (JP)

Correspondence Address: DICKSTEIN SHAPIRO MORIN & OSHINSKY LLP, 2101 L Street, NW, Washington, DC, 20037, US

(21) Appl. No.: 11/328,252

(22) Filed: Jan. 10, 2006

(30) Foreign Application Priority Data
Jan. 11, 2005 (JP) 2005-003989

(51) Int. Cl. H04Q 5/22

(52) U.S. Cl. 340/10.52; 340/572.1; 340/10.42

(57) ABSTRACT

A reader/writer device is disclosed that comprises plural channels corresponding to plural ID tags, and a controller that sends and receives data to and from the channels. Each of the channels includes an antenna unit and a modulation/demodulation unit that support a communications specification that the corresponding ID tag is compliant with. The controller enables communications according to the communications specification that the ID tag, which the data are to be sent to or received from, is compliant with.

### BACKGROUND OF THE INVENTION

1. Field of the Invention

The present invention relates to a reader/writer device.

2. Description of the Related Art

In recent years, the use of ID tags, for example, attached to products, has been increasing because of significant size reduction and price reduction thereof, and the amount of information that can be held within the ID tags, which is much greater than that of barcodes. For example, ID tags attached to products sold in shops store information about product details and distribution histories in their memories so that consumers can see the information by only putting a reader/writer close to the desired product.

FIG. 6 is a block diagram illustrating configurations of a typical reader/writer 200 and an ID tag 250. With reference to FIG. 6, the reader/writer 200 comprises a modulation bit encoding unit 202, a modulation circuit 204, a demodulation bit encoding unit 206, a demodulation circuit 208, a driver 210, an antenna 212, a reader/writer control unit 214, and a controller 216. The ID tag 250 comprises a modulation bit encoding unit 252, a modulation circuit 254, a demodulation bit encoding unit 256, a demodulation circuit 258, an antenna 260, a tag control unit 262, and a memory 264.

The controller 216 comprises a memory storing commands and information, and sends the commands and the information to the reader/writer control unit 214. The reader/writer control unit 214 for controlling communications of the reader/writer 200 sends the commands and the information from the controller 216 to the modulation bit encoding unit 202. The modulation bit encoding unit 202 converts the input commands and information into serial data encoded using, for example, NRZ encoding and Manchester encoding. The modulation circuit 204 modulates a carrier with the encoded data. The modulated carrier is amplified by the driver 210 and transmitted as a radio wave from the antenna 212. The driver 210 is activated by the reader/writer control unit 214 in advance of transmitting the radio wave.

When the antenna 260 of the ID tag 250 receives the radio wave transmitted from the reader/writer 200, an electromotive force is generated in the antenna 260. The electromotive force is rectified and supplied to various circuits (not shown) included in the ID tag 250. The demodulation circuit 258 demodulates signals received by the antenna 260, and then the demodulation bit encoding unit 256 converts encoded serial signals into digital signals so as to input the digital signals to the tag control unit 262. The tag control unit 262 for controlling communications of the ID tag 250 retrieves desired data from the memory 264 according to the signals input to the tag control unit 262 so as to send the retrieved data to the modulation bit encoding unit 252. The modulation bit encoding unit 252 encodes the data sent from the tag control unit 262 using, for example, NRZ encoding and Manchester encoding. The encoded data are modulated by the modulation circuit 254 and transmitted from the antenna 260.

The reader/writer 200 receives the data transmitted from the ID tag 250 with the antenna 212, and sends the received data to the demodulation circuit 208. The demodulation circuit 208 demodulates the data, and then the demodulation bit encoding unit 206 converts encoded serial signals into digital data. The digital data are input via the reader/writer control unit 214 to the controller 216, in which the digital data are processed.

Electric power for the ID tag 250 is generally supplied from the antenna 260 as described above. Therefore, the ID tag 250 returns signals to the reader/writer 200 using load modulation, which consumes less power. On the other hand, the reader/writer 200 generally uses ASK (Amplitude-Shift Keying) modulation, which provides high power transmission efficiency, because the power for the ID tag 250 is supplied from the antenna 212.

There are standards for communications between ID tags and readers/writers operating at 13.56 MHz: ISO 14443 for proximity communications and ISO 15693 for vicinity communications. Table 1 shows ISO 14443. Referring to Table 1, the modulation schemes and the encoding schemes used for sending signals from readers/writers to ID tags do not always match the modulation schemes and the encoding schemes used for sending signals from ID tags to readers/writers. For example, in Type A, the encoding scheme used for sending signals from readers/writers to ID tags is modified Miller encoding, whereas the encoding scheme used for sending signals from ID tags to readers/writers is Manchester encoding. The modulation scheme used for sending signals from readers/writers to ID tags is ASK modulation in all the types, Type A through Type C. On the other hand, the modulation scheme used for sending signals from ID tags to readers/writers is ASK subcarrier modulation in Type A, BPSK (Binary Phase Shift Keying) subcarrier modulation.

TABLE 1

| Communication System | | ISO 14443-2 | | |
|---|---|---|---|---|
| Type | | Type A | Type B | Type C |
| R/W→ID tag | Center Carrier Frequency | 13.56 MHz | | |
| | AM modulation | 100% | 10% | |
| | Subcarrier | No | | |
| | Modulation Scheme | ASK | | |
| | Encoding Scheme | Modified Miller | NRZ | Manchester |
| ID tag→R/W | Return link | Load Modulation | | |
| | Relationship with R/W | Send response when recognize unique | | |
| | | calling code | | |
| | Modulation Scheme | ASK | BPSK | ASK |
| | | subcarrier | subcarrier | |
| | Subcarrier | 847.5 kHz | | No |
| | Encoding Scheme | Manchester | NRZ | Manchester |
| | Transmission Speed | 106 kbps | | 212 kbps |

As can be seen, ISO 14443 describes three types of communication systems: Type A, Type B, and Type C, and they do not support each other. Moreover, ISO 14443 does not support ISO 15693. However, ISO 14443 and ISO 15693 specify the same carrier frequency (13.56 MHz) and the same modulation schemes. More specifically, ASK modulation is used for sending signals from reader/writers to ID tags, and load modulation is used in the return link in both ISO 14443 and ISO 15693. However, other than that, the bit encoding schemes and the transmission protocol specifications for exchanging data and commands are different between ISO 14443 and ISO 15693. Accordingly, for supporting ID tags compliant with different communication standards, different ID tag reader/writers compliant with the respective communication standards are used. Moreover, ID tags compliant with a communications specification cannot be used with ID tags compliant with a different communications specification.

### SUMMARY OF THE INVENTION

The present invention may solve at least one problem described above.

According to an aspect of the present invention, there is provided an inexpensive reader/writer device with small circuit size, capable of controlling different types of ID tags.

According to another aspect of the present invention, there is provided a reader/writer device that comprises plural channels corresponding to plural ID tags, and a controller that sends and receives data to and from the channels. Each of the channels includes an antenna unit and a modulation/demodulation unit that support a communications specification that the corresponding ID tag is compliant with. The controller enables communications according to the communications specification that the ID tag, which the data are to be sent to or received from, is compliant with.

According to still another aspect of the present invention, there is provided a reader/writer device that comprises a first channel corresponding to a first communication system, a second channel corresponding to a second communication system that is different from the first communication system, and a controller that sends and receives data to and from the first and second channels, wherein the controller selects a communications specification corresponding to the first channel or a communications specification corresponding to the second channel.

According to the present invention, ID tags compliant with different communications specifications can be controlled by a single reader/writer device. Further, ID tags compliant with a communications specification can be used with ID tags compliant with a different communications specification.

### BRIEF DESCRIPTION OF THE DRAWINGS

FIG. 1 is a functional block diagram illustrating a reader/writer according to a first embodiment of the present invention;

FIG. 2 is a functional block diagram illustrating a reader/writer controller of FIG. 1;

FIG. 3 is a block diagram illustrating functions of a transmission protocol analyzing unit and an encoding modulation/demodulation unit of FIG. 2;

FIG. 4 is another block diagram illustrating functions of a transmission protocol analyzing unit and an encoding modulation/demodulation unit of FIG. 2;

FIG. 5 is a functional block diagram illustrating a reader/writer according to a second embodiment of the present invention; and

FIG. 6 is a block diagram illustrating configurations of a reader/writer and an ID tag.

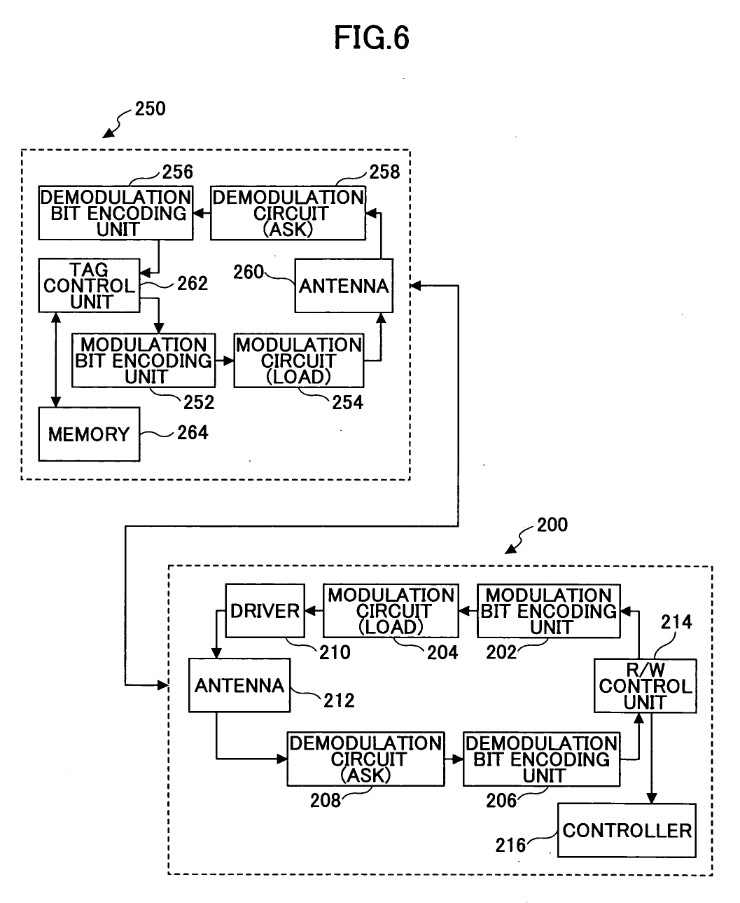

### DETAILED DESCRIPTION OF THE PREFERRED EMBODIMENT

The following description provides exemplary embodiments of the present invention with reference to the accompanying drawings.

### First Embodiment

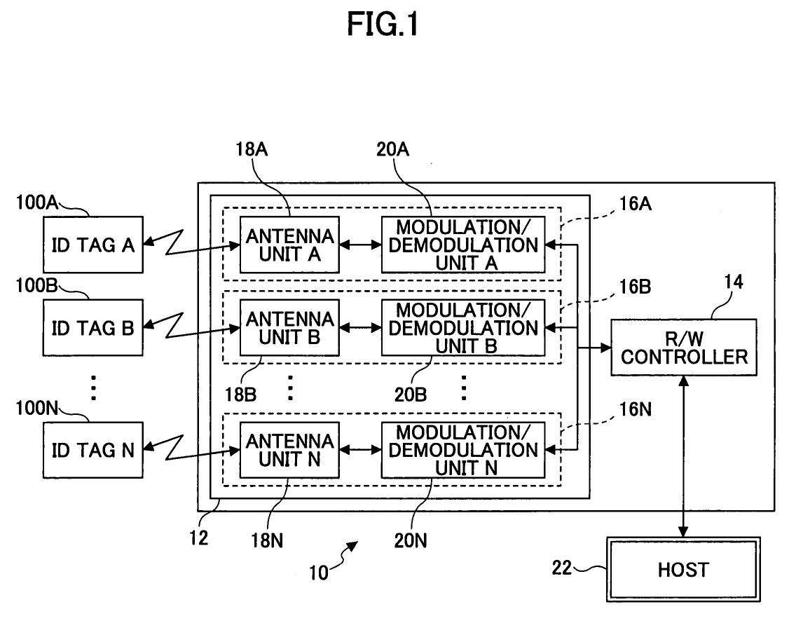

FIG. 1 is a functional block diagram illustrating a reader/writer device 10 according to a first embodiment of the present invention. The reader/writer device shown in FIG. 1 comprises an analog front end unit (hereinafter referred to as “front end unit”) 12 and a reader/writer controller (control unit) 14. The front end unit 12 comprises plural channels 16 (16A-16N) corresponding to plural ID tags 100 (100A-100N) supporting different communications specifications. The channels 16 (16A-16N) comprise respective antenna units 18 (18A-18N) and modulation/demodulation units 20 (20A-20N). Communication specifications of the antenna units 18 (18A-18N) and the modulation/demodulation units 20 (20A-20N) correspond to the communications specifications of the corresponding ID tags 100 (100A-100N). That is, the channel 16A can communicate only with the ID tag 100A, the channel 16B can communicate only with the ID tag 100B, . . . , and the channel 16N can communicate only with the ID tag lOON. The reader/writer controller 14 can send and receive signals to and from the channels 16 (16A-16N). The reader/writer controller 14 can also send and receive signals to and from a host 22.

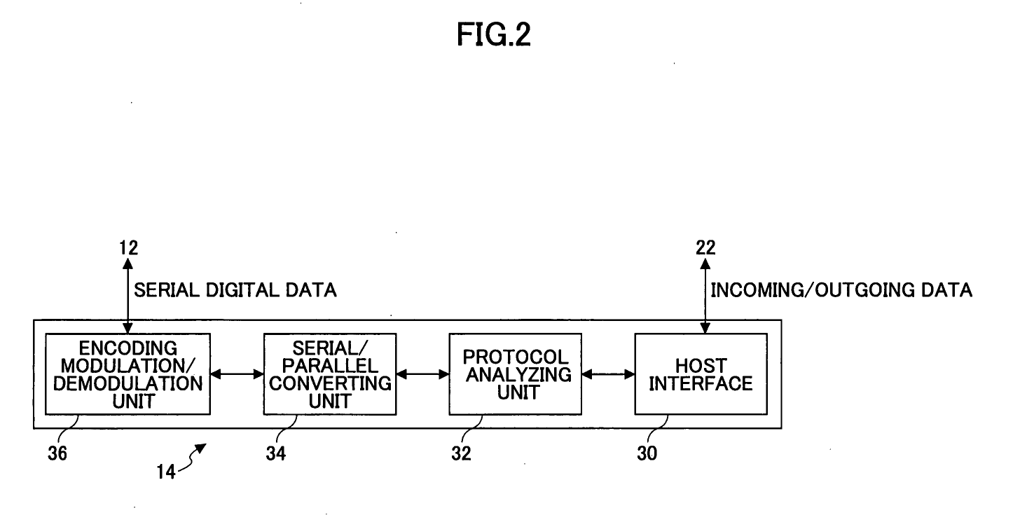

FIG. 2 is a functional block diagram illustrating the reader/writer controller 14. As shown in FIG. 2, the reader/writer controller 14 comprises a host interface 30 that sends and receives signals to and from the host 22, a transmission protocol analyzing unit (selecting unit) 32 that selects a transmission protocol to be used for sending and receiving data to and from the ID tags 100 (100A-100N) and performs protocol analysis on the data based on the selected transmission protocol, a serial/parallel converter 34 that converts serial data into parallel data and converts parallel data into serial data, and an encoding modulation/demodulation unit 36 that performs bit encoding modulation and bit decoding demodulation of the data to be sent to and received from the ID tags 100 (100A-100N) according to corresponding communications specifications. Examples of bit encoding modulation/demodulation schemes include a Manchester encoding scheme and a Miller encoding scheme.

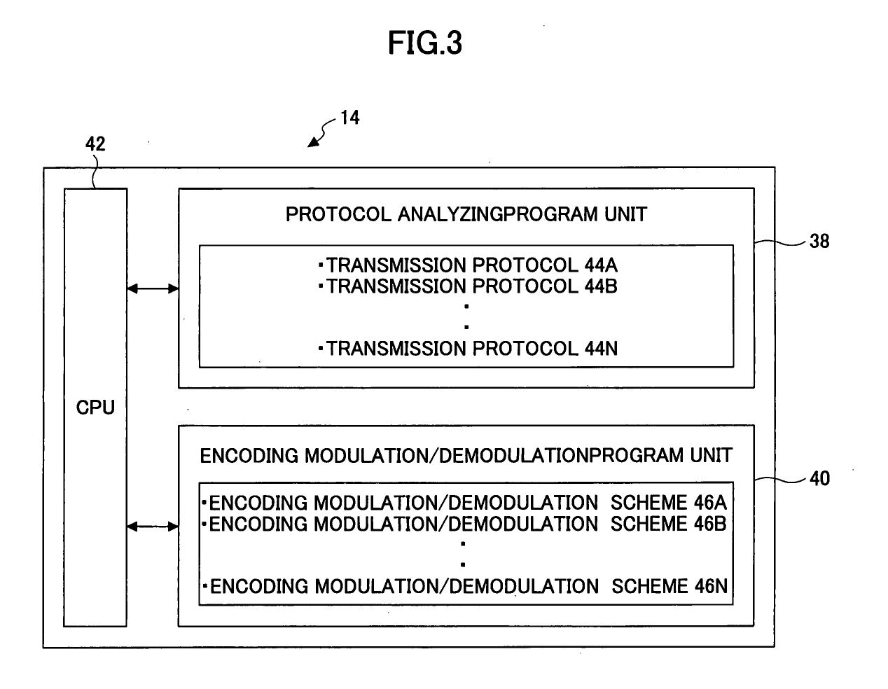

FIG. 3 is a block diagram illustrating components associated with the transmission protocol analyzing unit 32 and the encoding modulation/demodulation unit 36. As shown in FIG. 3, the reader/writer controller 14 further comprises a protocol analyzing program unit 38 associated with the transmission protocol analyzing unit 32, an encoding modulation/demodulation program unit 40 associated with the encoding modulation/demodulation unit 36, and a CPU 42. The protocol analyzing program unit 38 includes transmission protocols 44 (44A-44N) corresponding to the ID tags 100 (100A-100N) so as to perform protocol analysis on outgoing data according to the communications specification of the destination ID tag, and to perform protocol analysis on incoming data according to the communications specification of the source ID tag. The encoding modulation/demodulation program unit 40 includes encoding modulation/demodulation schemes 46 (46A-46N) corresponding to the ID tags 100 (100A-100N) so as to encode and modulate outgoing data according to the communications specification of the destination ID tag, and to decode and demodulate incoming data according to the communications specification of the source ID tag. Examples of the encoding modulation/demodulation schemes 46 (46A-46N) include the Manchester encoding scheme and the Miller encoding scheme.

When the host 22 sends a data item to the certain ID tag 100 (one of 100A, . . . , and 100N), the outgoing data item from the host 22 is input via the host interface 30 to the transmission protocol analyzing unit 32 of the reader/writer controller 14. The outgoing data item contains a command, destination information (destination ID tag information), and contents. The transmission protocol analyzing unit 32, more specifically, the CPU 42, selects the transmission protocol 44 (one of 44A, . . . , and 44N) corresponding to the destination ID tag 100 based on the destination ID tag information contained in the outgoing data item, and creates a communication protocol data item conforming to the communication protocol specification of the destination ID tag 100 based on the selected transmission protocol. The communication protocol data item is converted into a serial data item by the serial/parallel converter 34. Then, the encoding modulation/demodulation unit 36 performs bit encoding modulation of the serial data item according to the communications specification of the destination ID tag 100. In this bit encoding modulation process, the encoding modulation/demodulation unit 36, more specifically, the CPU 42, selects the encoding modulation/demodulation scheme 46 (one of 46A, . . . , and 46N) corresponding to the destination ID tag 100 based on the destination ID tag information, and performs encoding modulation of the outgoing data item to conform to the communications specification of the destination ID tag 100 based on the selected encoding modulation/demodulation scheme 46. The reader/writer controller 14 selects the channel 16 (one of 16A, . . . , and 16N) corresponding to the destination ID tag 100 based on the destination ID tag information, and sends the encoded data item (encoded serial digital signals) to the selected destination channel 16. In order to send data items to a desired one of the modulation/demodulation units 20 (20A-20N) of the channels 16 (16A-16N), predetermined addresses specific to the individual modulation/demodulation units 20 (one of 20A, . . . , 20N) are stored in the reader/writer controller 14. The reader/writer controller 14 can therefore send the encoded data item to the modulation/demodulation unit 20 of the selected destination channel 16.

The modulation/demodulation unit 20 of the destination channel 16 modulates a carrier based on the received encoded data item. Frequencies f (fa-fn) of carriers to be modulated by the modulation/demodulation units 20 (20A-20N) are different from each other. In this embodiment, the modulation/demodulation units 20 (20A-20N) use ASK modulation. The modulated data item is sent to the destination ID tag 100 from the corresponding antenna unit 18 (one of 18A, , and 18N).

The destination ID tag 100 receives the data item sent from the antenna unit 18. When the ID tag 100 receives the data item, i.e., the encoded serial data signals, an electromotive force is generated in an antenna unit (not shown) of the ID tag 100. The ID tag 100 rectifies the electromotive force and supplies the rectified electromotive force to circuits (not shown) included in the ID tag 100. In the ID tab 100, the received signals are demodulated by an ASK demodulation circuit (not shown). Then, a demodulation bit decoding unit (not shown) converts the encoded serial signals into digital signals. A tag control unit (not shown) for controlling communications of the ID tag 100 retrieves a desired data item from a memory (not shown) according to the digital signals so as to send the retrieved data item to a modulation bit encoding unit (not shown). The modulation bit encoding unit encodes the data item received from the memory according to a predetermined communications specification (encoding scheme). The encoded data item is load modulated by a modulation circuit (not shown) and then sent from the ID tag 100 to the corresponding channel 16.

Communications between the reader/writer device 10 and the ID tags 100 (100A-100N) may utilize any of electromagnetic coupling, electromagnetic induction, and radio waves.

In the channel 16 of the reader/writer device 10, the antenna unit 18 receives the data item, i.e., signals from the ID tag 100, and the modulation/demodulation unit 20 demodulates the received signals. Demodulation may be performed using, for example, the ASK demodulation scheme, phase detection, and reflected wave detection. The modulated signals are converted into a serial digital data item by the modulation/demodulation unit 20 so as to be output to the reader/writer controller 14.

In the reader/writer controller 14, the encoding modulation/demodulation unit 36, more specifically, the CPU 42, selects the encoding modulation/demodulation scheme 46 (one of 46A, . . . , and 46N) corresponding to the communications specification of the source ID tag 100 based on the address of the channel 16 that has output the serial digital data item to the reader/writer controller 14, and performs bit decoding demodulation according to the selected encoding modulation/demodulation scheme 46. The demodulated data item is converted into a parallel data item by the serial/parallel converter 34. Then, the transmission protocol analyzing unit 32 selects the transmission protocol 44 (one of 44A, . . . , and 44N) corresponding to the communications specification of the source ID tag 100 based on the address of the channel 16, and analyzes the converted data item based on the selected transmission protocol so as to obtain information from the incoming data item (including a response command, data information, etc.). The obtained data item is sent from the host interface 30 of the reader/writer controller 14 to the host 22.

In this first embodiment, since the channels 16 (16A-16N) comprise the antenna units 18 (18A-18N) and the modulation/demodulation units 20 (20A-20N), the reader/write device 10 can support the ID tags 100 (100A-100N) compliant with the different communications specifications. Further, since the channels 16 comprise antenna units 18 supporting the different communications specifications, the reader/write device 10 can support the ID tags 100 using different carrier frequencies with the corresponding channels 16. The reader/writer device 10 may have a channel corresponding to an ID tag that uses a carrier having long wavelength with a frequency of a few hundred KHz other than a frequency of 13.56 KHz. In general, different bands of carriers require different forms of antennas. As the reader/writer device 10 has the antenna units 20 in the respective channels 16, the reader/writer device 10 can communicate with the plural ID tags 100 compliant with the different communications specifications even when the carrier specifications of the channels 16 are different. Moreover, the reader/writer device 10 can support the different transmission protocols and the different encoding modulation/demodulation schemes by changing programs in the reader/writer controller 14.

The channels 16 comprise the channel modulation/demodulation units 20 that use the different modulation/demodulation schemes to correspond to the ID tags 100 using the different communications specifications. Therefore, the ID tags 100 compliant with the different communications specifications can be used with the corresponding channels 16. Upon demodulation of the signals received from the ID tag 100, a demodulation scheme is selected that suits a carrier for the signals, output of the antenna unit 16 corresponding to the ID tag 100, and the communication distance to the ID tag 100. Some communications specifications require the use of a sub carrier. However, since the modulation/demodulation units 20 of the channels 16 are independent from each other as described above, modulation and demodulation can be performed according to the communications specification of each ID tag 100. Moreover, since all the data input to and output from the modulation/demodulation units 20 are digital data, it is possible to control all the channels 16 and data input and output with the single reader/writer controller 14.

### Modified Embodiment 1

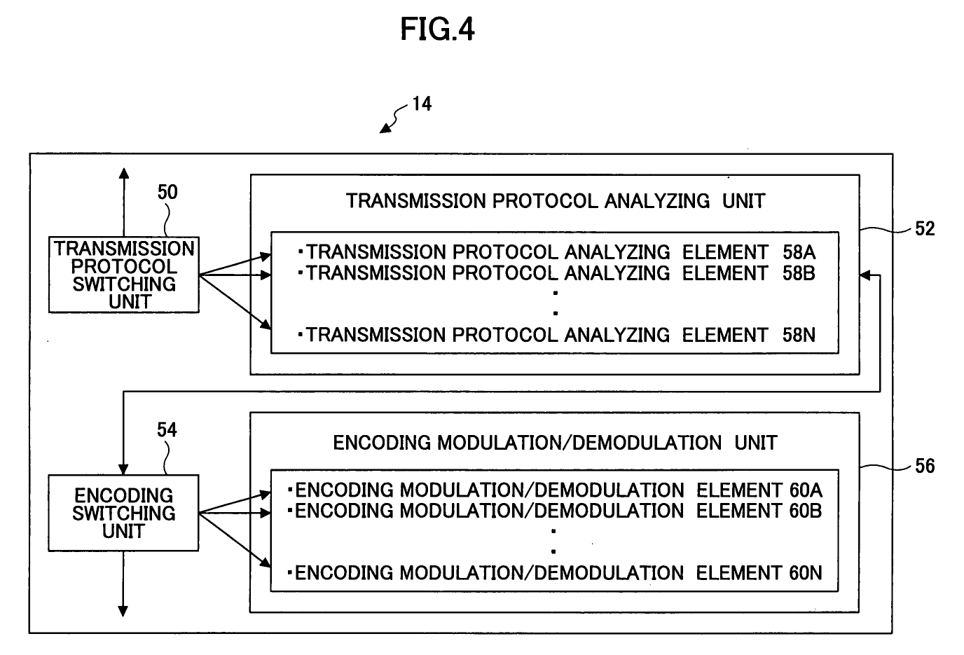

In the first embodiment, the transmission protocol analysis and encoding modulation/demodulation are performed according to programs incorporated in the CPU 42 of the reader/writer controller 14. However, the structure and operations of the transmission protocol analysis and encoding modulation/demodulation are not limited to those described in the first embodiment. For example, FIG. 4 illustrates components for transmission protocol analysis and encoding modulation/demodulation according to a modified embodiment 1. In the modified embodiment 1, the reader/writer controller 14 comprises a transmission protocol switching unit 50, a transmission protocol analyzing unit 52, an encoding switching unit 54, and an encoding modulation/demodulation unit 56. The transmission protocol analyzing unit 52 includes transmission protocol analyzing elements 58A-58N corresponding to ID tags compliant with different communications specifications. Similarly, the encoding modulation/demodulation unit 56 includes encoding modulation/demodulation elements 60A-60N corresponding to the ID tags compliant with the different communications specifications. The analyzing elements 58A-58N and the encoding modulation/demodulation elements 60A-60N may be formed with programs or physical circuits. Accordingly, the reader/writer device 10 can support the different communications specifications by only changing the program or hardware configuration.

According to the modified embodiment 1, the transmission protocol switching unit 50 selects one of the transmission protocol analyzing element 58 (one of protocol analyzing elements 58A-58N) corresponding to destination information (or communications specification information) contained in an outgoing data item from the host 22 or source (ID tag) information contained in an incoming data item from the channel 16 (one of the channels 16A-16N). Then, the transmission protocol switching unit 50 performs transmission protocol analysis using the selected analyzing element 58. Similarly, the encoding switching unit 54 selects the encoding modulation/demodulation element 60 (one of the encoding modulation/demodulation elements 60A-60N) corresponding to the destination information (or communications specification information) contained in the outgoing data item from the host 22 or the source (ID tag) information contained in the incoming data item from the channel 16 (one of the channels 16A-16N). Then, the encoding switching unit 54 performs encoding demodulation/demodulation of the data items using the selected encoding modulation/demodulation element 60.

### Modified Embodiment 2

In the above-described embodiments, the reader/writer controller 14 selects or switches to the appropriate transmission protocol and encoding modulation/demodulation scheme based on destination information or source information contained in an outgoing data item or an incoming data item. On the other hand, in a modified embodiment 2, the host 22 sends the destination information to the reader/writer controller 14 separately from the outgoing data item such that the reader/writer controller 14 selects appropriate transmission protocol, encoding modulation/demodulation scheme, and channel based on the destination information sent separately from the outgoing data item.

### Modified Embodiment 3

An ID tag to be communicating with the reader/writer device 10 and a communications specification required for the communication can be determined without using the signals output from the host 22. For example, the host 22 creates outgoing data items compliant with different communications specifications. The created outgoing data items are sequentially output from corresponding channels. Then, replies from ID tags that have responded to the output data items are received by the corresponding channels. The channels send signals based on the replies to the reader/writer controller 14. The reader/writer controller 14 determines a communications specification of the ID tag with which the reader/writer device 10 is to communicate based on the signals received from the channels. Then, the reader/writer device 10 communicates with the thus determined ID tag according to the thus determined communications specification.

### Second Embodiment

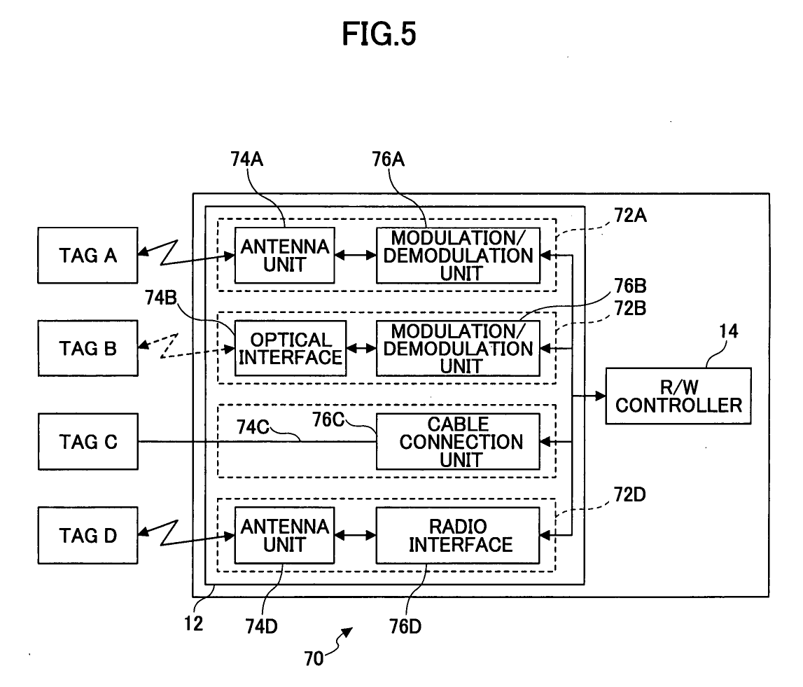

FIG. 5 illustrates a reader/writer device 70 according to a second embodiment of the present invention. The reader/writer device 70 comprises a channel (first channel) 72A using the same communication system as ID tags, and channels (second channels) 72B, 72C, and 72D using communication systems different from the communication system of the ID tags. Examples of the communication systems different from the communication system of the ID tags include optical communication systems, cable communication systems, and radio communication systems. In the second embodiment, the channels 72B, 72C, and 72D use an optical communication system, a cable communication system, and a radio communication system, respectively. The channel 72A using the same communication system as the ID tags comprises an antenna unit 74A and a modulation/demodulation unit 76A as in the first embodiment. The channel 72B using the optical communication system comprises an optical interface 74B and a modulation/demodulation unit 76B. The modulation/demodulation unit 76B is a modulation/demodulation unit for optical communications. The channel 72C using the cable communication system comprises a cable 74C and a cable connection unit 76C in place of an antenna unit and a modulation/demodulation unit. The channel 72D using the radio communication system comprises an antenna unit 74D and a radio interface 76D. The reader/writer controller 14 identifies a channel to be communicated with based on outgoing data, channel information sent from a host, or output from the channel that has received a response. The reader/writer device 70 having the above-described configuration can support plural communication systems even if the transmission system differs from channel to channel. Moreover, since all the data input to and output from the plural channels are serial digital data, it is possible to control all the channels and data input and output with the single reader/writer controller 14.

The present application is based on Japanese Priority Application No. 2005-003989 filed on Jan. 11, 2005, with the Japanese Patent Office, the entire contents of which are hereby incorporated by reference.

What is claimed is:

1. A reader/writer device comprising:
a plurality of channels corresponding to a plurality of ID tags, each of the channels including. an antenna unit and a modulation/demodulation unit that support a communications specification that the corresponding ID tag is compliant with; and
a controller that sends and receives d.ata to and from the channels;
wherein the controller enables communications according to the communications specification that the ID tag, which the data are to be sent to or received from, is compliant with.

2. The reader/writer device as claimed in claim 1, wherein each of the channels outputs a carrier having a frequency corresponding to the communications specification with which the corresponding ID tag is compliant.

3. The reader/writer device as claimed in claim 1, wherein the controller selects a transmission protocol based on outgoing data input to the controller.

4. The reader/writer device as claimed in claim 1, wherein the controller includes a transmission protocol switching unit that selects a transmission protocol corresponding to the communications specification that the ID tag, which the data are to be sent to or received from, is compliant with.

5. The reader/writer device as claimed in claim 1, wherein the controller selects an encoding modulation/demodulation scheme based on outgoing data input to the controller.

6. The reader/writer device as claimed in claim 1, wherein the controller includes an encoding switching unit that selects an encoding modulation/demodulation scheme corresponding to the communications specification with which the ID tag, which the data are to be sent to or received from, is compliant.

7. The reader/writer device as claimed in claim 1, wherein the controller creates signals corresponding to the communications specifications of the ID tags and outputs the signals from the corresponding channels so as to determine a transmission protocol and an encoding modulation/demodulation scheme based on signals returned by the ID tags in response to the signals output from the channels.

8. A reader/writer device comprising:
a first channel corresponding to a first communication system;
a second channel corresponding to a second communication system that is different from the first communication system; and
a controller that sends and receives data to and from the first and second channels;
wherein the controller selects a communications specification corresponding to the first channel or a communications specification corresponding to the second channel.

9. The reader/writer device as claimed in claim 8, wherein the second communication system is an optical communication system.

10. The reader/writer device as claimed in claim 8, wherein the second communication system is a cable communication system in which the data are transmitted through a cable.

11. The reader/writer device as claimed in claim 8, wherein the second communication system is a radio communication system.
